(19) United States
(12) Patent Application Publication
(10) Pub. No.: US 2026/0054326 A1
(43) Pub. Date: Feb. 26, 2026

(54) WELDING DEVICE

(71) Applicant: Wuxi Lead Intelligent Equipment Co., Ltd., Jiangsu (CN)

(72) Inventor: JUNFENG SU, Jiangsu (CN)

(73) Assignee: Wuxi Lead Intelligent Equipment Co., Ltd., Jiangsu (CN)

(21) Appl. No.: 19/272,581

(22) Filed: Jul. 17, 2025

Related U.S. Application Data
(63) Continuation of application No. PCT/CN2024/100437, filed on Jun. 20, 2024.

(30) Foreign Application Priority Data
May 6, 2023 (CN) 202321080883.2

(51) Int. Cl. B23K 26/70; B23K 26/21; B23K 37/04; B23K 101/36

(52) U.S. Cl. CPC B23K 26/702; B23K 26/21; B23K 37/04; B23K 2101/36

(57) ABSTRACT

A welding device includes a rotating assembly, a bearing mechanism provided on the rotating assembly and actuated by the rotating assembly to rotate about a first axis, thereby cycling through a welding zone, an unloading zone, and a loading zone; the bearing mechanism includes at least a fixing assembly, which is switchable between a first state and a second state, wherein the fixing assembly fixes a battery, and at least a part of the fixing assembly is rotatable about a second axis to actuate the battery to rotate about the second axis in the first state; wherein the fixing assembly releases the battery in the second state; a laser welding device including at least a laser unit and a galvanometer unit, and the galvanometer unit being configured to deflect a laser emitted by the laser unit.

### CROSS-REFERENCE TO RELATED APPLICATIONS

The present disclosure is a continuation of International Application No. PCT/CN2024/100437, filed on Jun. 20, 2024, which claims priority to a Chinese patent application No. 202321080883.2 filed with the China National Intellectual Property Administration (CNIPA) on May 6, 2023 and entitled “WELDING DEVICE”, both of which are hereby incorporated by reference in their entireties.

### TECHNICAL FIELD

The present disclosure relates to a welding device.

### BACKGROUND

In the current lithium battery industry, the seal weld of the cylindrical battery end cover is typically performed using a side-welding configuration with the welding head. This method involves intermittent welding, during which the battery must be mechanically positioned prior to each laser welding cycle. Additionally, welding and battery movement cannot be conducted simultaneously, resulting in an extended takt time that fails to meet the demands of the high-speed production lines for cylindrical batteries.

### SUMMARY

The present disclosure provides a new technical solution for a welding device, which can solve at least the problem of low production efficiency of the battery caused by the inability of existing welding devices to supply the battery while welding.

According to a first aspect of the present disclosure, a welding device is provided, which includes a rotating assembly; at least a bearing mechanism provided on the rotating assembly and actuated by the rotating assembly to rotate about a first axis so that the bearing mechanism cycles through a welding zone, an unloading zone, and a loading zone; wherein the bearing mechanism includes at least a fixing assembly, which is switchable between a first state and a second state; when the fixing assembly is in the first state, the fixing assembly fixes a battery, and at least a part of the fixing assembly is rotatable about a second axis to actuate the battery to rotate about the second axis; when the fixing assembly is in the second state, the fixing assembly releases the battery; and a laser welding device, the laser welding device including at least a laser unit and a galvanometer unit, and the galvanometer unit being configured to deflect a laser emitted by the laser unit so that the laser welds a welding part of the battery when the battery is rotated about the first axis and the second axis.

Optionally, the rotating assembly includes: a base and a rotating frame, the rotating frame being rotatably provided on the base about the first axis, and the fixing assembly being provided on the rotating frame; and a first driving member being in transmission connection with the rotating frame to drive the rotating frame to rotate about the first axis.

Optionally, the fixing assembly includes: a first mounting seat and a first pressing head, the first mounting seat being provided on the rotating assembly, and the first pressing head being rotatably provided on the first mounting seat about the second axis; a second mounting seat and a second pressing head, the second pressing head being arranged spaced apart along the second axis direction from the first pressing head, and the second pressing head being rotatably provided on the second mounting seat about the second axis; wherein the first mounting seat and/or the second mounting seat is movably provided on the rotating assembly along a direction of the second axis, so that the fixing assembly is switchable between the first state and the second state.

Optionally, the second mounting seat is movable along the direction of the second axis, and the fixing assembly further includes: a second driving member provided on the second mounting seat and driving the second mounting seat to move along a length direction of the second axis, so that the first pressing head and the second pressing head cooperate to clamp the battery; and a third driving member being in transmission connection with the first pressing head or the second pressing head to drive the first pressing head or the second pressing head to rotate, the first pressing head and the second pressing head cooperating to drive the battery to rotate about the second axis.

Optionally, the first mounting seat is movable along a length direction of the second axis, and the fixing assembly further includes: a fourth driving member provided on the first mounting seat to drive the second mounting seat to move along the length direction of the second axis.

Optionally, the second pressing head is movably provided on the second mounting seat along a length direction of the second axis, and the fixing assembly further includes: a first elastic member provided between the second pressing head and the second mounting seat, a first end of the first elastic member abutting against the second pressing head, and a second end of the first elastic member abutting against the second mounting seat.

Optionally, the second driving member includes: a guiding cam provided on the base and provided with a guiding part extending in a circumferential direction of the first axis, the guiding part including a protruding section protruding along a length direction of the first axis and a recessed section recessed along the length direction of the first axis; and a transmission part connected to the second mounting seat, rotatably abutting against the guiding part about the first axis, and cooperating with the protruding section and the recessed section to drive the second mounting seat to move along the length direction of the second axis.

Optionally, the second driving member further includes: an adapter member, the transmission part being rotatably provided on the adapter member about its own axis, and the adapter member being movably provided on the second mounting seat along the length direction of the second axis; and a second elastic member provided between the adapter member and the second mounting seat, a first end of the second elastic member abutting against the adapter member, and a second end of the second elastic member abutting against the second mounting seat.

Optionally, the bearing mechanism further includes: two limit rollers, axes of the two limit rollers being parallel to the second axis, and the two limit rollers being spaced apart in a radial direction of the battery, being rotatably provided on the rotating assembly about their own axes, and cooperating to bear the battery.

Optionally, the laser welding device further includes: a position sensor configured to detect a position of the battery in the welding zone.

According to the welding device of the present disclosure, the provision of the rotating assembly and the fixing assembly, together with the laser welding device having the laser unit and the galvanometer unit, enables the rotating assembly to actuate the fixing assembly to cycle through the welding zone, the unloading zone, and the loading zone. The fixing assembly may fix the battery and, while fixing the battery, may actuate the battery to rotate about its own axis. Meanwhile, the galvanometer unit may deflect the laser emitted by the laser unit. As a result, during the process of the welding device welding the battery, the battery remains in motion and can move towards the unloading zone concurrently with the welding operation, thereby reducing the takt time of the battery and improving production efficiency.

Other features and advantages of the present disclosure will become apparent from the following detailed description of exemplary embodiments of the present disclosure with reference to the accompanying drawings.

### BRIEF DESCRIPTION OF THE DRAWINGS

The accompanying drawings incorporated in and constituting a part of the specification illustrate embodiments of present disclosure and together with the description thereof, serve to explain the principles of the disclosure.

FIG. 1 is a structural schematic diagram of a welding device according to an embodiment of the present disclosure;

FIG. 2 is a structural schematic diagram of a welding device according to another embodiment of the present disclosure;

FIG. 3 is a front view of a fixing assembly of a welding device according to an embodiment of the present disclosure;

FIG. 4 is a right view of the fixing assembly of a welding device according to an embodiment of the present disclosure;

FIG. 5 is a structural schematic diagram of a part of the fixing assembly of a welding device according to an embodiment of the present disclosure;

FIG. 6 is a sectional view taken along line A-A in FIG. 5;

FIG. 7 is a structural schematic diagram of another part of the fixing assembly of a welding device according to an embodiment of the present disclosure;

FIG. 8 is a sectional view taken along line B-B in FIG. 7;

FIG. 9 is a distribution diagram of a protruding section and a recessed section of a welding device according to an embodiment of the present disclosure on a guiding part.

### DESCRIPTION OF REFERENCE SIGNS:

welding device 100; rotating assembly 10; base 11; rotating frame 12; first driving member 13;
fixing assembly 20; first mounting seat 21; first pressing head 22; second mounting seat 23; second pressing head 24; mounting plate 25;
second driving member 30; guiding cam 31; guiding part 32; protruding section 321; recessed section 322; transmission part 33; adapter member 34; second elastic member 35;
third driving member 40; fourth driving member 50; first elastic member 60; limit roller 70;
laser welding device 80; laser unit 81; galvanometer unit 82;
battery 200.

### DETAILED DESCRIPTION

Various exemplary embodiments of the present disclosure will now be described in detail with reference to the accompanying drawings. It is to be noted that unless otherwise specified, the relative arrangements, numerical expressions and values of components and steps illustrated in the embodiments do not limit the scope of the present disclosure.

The description of at least one exemplary embodiment is for illustrative purpose only and in no way implies any restriction on the present disclosure, its application, or use.

Techniques, methods and devices known to those skilled in the prior art may not be discussed in detail; however, such techniques, methods and devices shall be regarded as part of the description where appropriate.

In all the examples illustrated and discussed herein, any specific value shall be interpreted as illustrative rather than restrictive. Therefore, other examples of the exemplary embodiments may have different values.

It is to be noted that similar reference numbers and alphabetical letters represent similar items in the accompanying drawings. Once an item is defined in one drawing, further reference to it may be omitted in subsequent drawings.

Below, the welding device 100 according to the embodiments of the present disclosure will be specifically described with reference to the accompanying drawings.

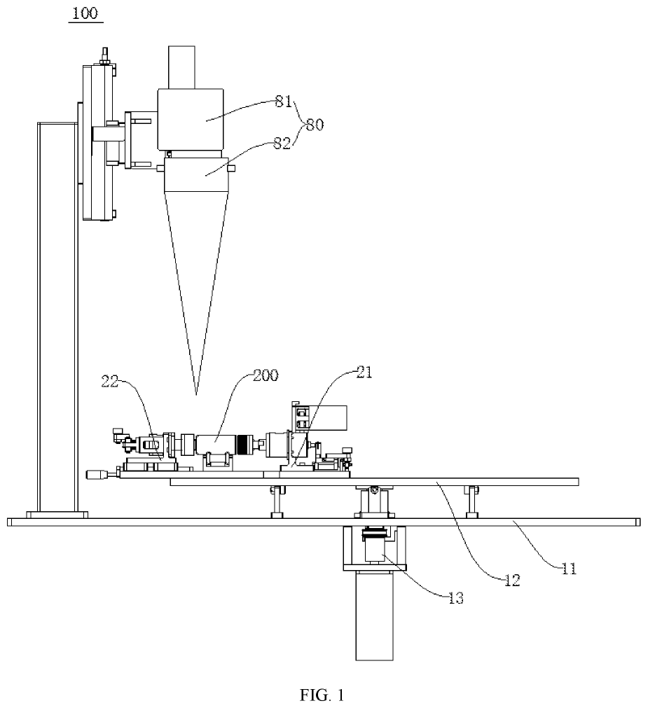

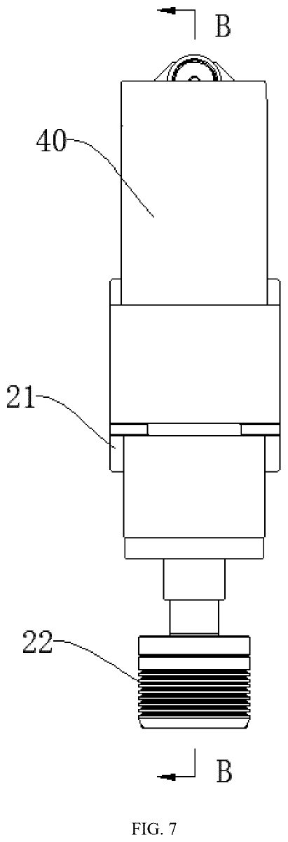

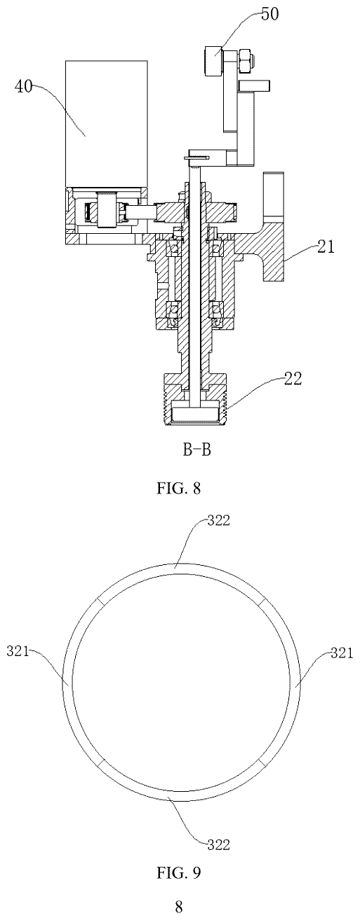

As shown in FIGS. 1 to 8, the welding device 100 according to the embodiments of the present disclosure includes: a rotating assembly 10, a laser welding device 80, and at least one bearing mechanism.

Specifically, the bearing mechanism is provided on the rotating assembly 10 and is actuated by the rotating assembly 10 to rotate about the first axis, so that the bearing mechanism cycles through the welding zone, the unloading zone, and the loading zone. The bearing mechanism includes at least a fixing assembly 20, which is switchable between a first state and a second state. When the fixing assembly 20 is in the first state, it fixes the battery 200, and at least a part of the fixing assembly 20 is rotatable about the second axis to actuate the battery 200 to rotate about the second axis. When the bearing mechanism is rotated about the first axis in the unloading zone and the fixing assembly 20 is in the second state, the fixing assembly 20 releases the battery 200. The laser welding device 80 includes at least a laser unit 81 and a galvanometer unit 82, and the galvanometer unit 82 is configured to deflect the laser emitted by the laser unit 81, so that the laser welds the welding part of the battery 200 when the battery 200 is rotated about the first axis and the second axis.

In other words, as shown in FIGS. 1 to 8, the welding device 100 according to the embodiments of the present disclosure mainly consists of a rotating assembly 10, a laser welding device 80, and a bearing mechanism. Herein, the bearing mechanism can be one or multiple. Here, an example with one bearing mechanism will be described in detail. The bearing mechanism includes at least one fixing assembly 20, which is installed on the rotating assembly 10. The welding zone, unloading zone, and loading zone are arranged around the outer periphery of the rotating assembly 10. The rotating assembly 10 may continuously actuate the fixing assembly 20 to rotate about the first axis, allowing the fixing assembly 20 to cycle through the welding zone, unloading zone, and loading zone. Moreover, the fixing assembly 20 has a first state and a second state, wherein the first state can be a fixing state the second state can be a releasing state, and the fixing assembly 20 is switchable between these two states.

As shown in FIGS. 1 to 4, when the fixing assembly 20 is in the first state, it can fix the battery 200, and a part of the fixing assembly 20 is rotatable about the second axis. The second axis can be the same as the axis of the battery 200, so that when the fixing assembly 20 fixes the battery 200, it can actuate the battery 200 to rotate about the second axis. When the fixing assembly 20 is in the second state, it can release the battery 200.

The laser welding device 80 is located on one side of the bearing mechanism and is spaced apart from it. The laser welding device 80 includes a laser unit 81 and a galvanometer unit 82, and the galvanometer unit 82 can be a laser galvanometer and is configured to deflect the laser emitted by the laser unit 81. When the laser welding device 80 is in operation, the laser is emitted from the laser source to the galvanometer unit 82, and the galvanometer unit 82 implements deflection of the laser in the x-axis, y-axis, and z-axis directions, thereby allowing the laser to weld the welding part of the battery 200 according to a predetermined trajectory.

When the welding device 100 is in use, the rotating assembly 10 continuously actuates the fixing assembly 20 to rotate about the first axis, such that the fixing assembly 20 cycles through the welding zone, unloading zone, and loading zone. When the fixing assembly 20 is in the welding zone, it is in the first state, fixes the battery 200, and actuates the battery 200 to spin about the second axis, such that the battery 200 revolves about the first axis while being welded, and the laser welding device 80 continuously welds the battery 200 while the battery 200 is spinning and revolving.

When the fixing assembly 20 is in the loading zone, a robot arm or other mechanism may be used to install the battery 200 onto the fixing assembly 20. The fixing assembly 20 is then switched from the second state to the first state to fix the battery 200, and subsequently moves into the welding zone under the action of the rotating assembly 10.

After the fixing assembly 20 enters the welding zone, it actuates the battery 200 to spin about the second axis, and meanwhile, the laser welding device 80 emits a laser that can be directed to the gap between the steel shell and the end cap of the battery 200. The path traveled by the battery 200 during one complete rotation thereof is within the scanning range of the galvanometer, allowing the laser to complete the welding within the scanning range of the galvanometer.

After the fixing assembly 20 passes through the welding zone, it moves to the unloading zone, switches to the second state, and releases the fixation on the battery 200, allowing the battery 200 to be detached from the fixing assembly 20. After the fixing assembly 20 passes through the welding zone, it moves to the unloading zone.

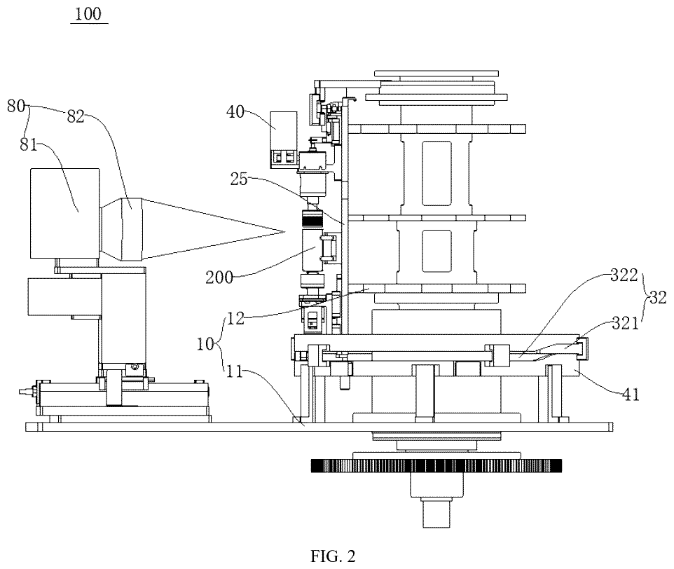

As shown in FIGS. 1 and 2, the length direction of the first axis can be a vertical direction, and the length direction of the second axis can be either a vertical direction or horizontal direction, which can be specifically determined according to actual needs and will not be described again in the present embodiment.

Thus, according to the welding device 100 provided by the embodiments of the present embodiment, the provision of the rotating assembly 10 and the fixing assembly 20, together with the laser welding device 80 having the laser unit 81 and the galvanometer unit 82, enables the rotating assembly 10 to actuate the fixing assembly 20 to cycle through the welding zone, the unloading zone, and the loading zone. The fixing assembly 20 may fix the battery 200 and, while fixing it, may actuate the battery 200 to rotate about its own axis. Meanwhile, the galvanometer unit 82 may deflect the laser emitted by the laser unit 81. As a result, during the process of the welding device 100 welding the battery 200, the battery 200 remains in motion and can move towards the unloading zone concurrently with the welding operation, thereby reducing the takt time of the battery 200 and improving production efficiency.

According to one embodiment of the present disclosure, there is a plurality of bearing mechanisms, which are distributed about the first axis on the outer periphery of the rotating assembly 10.

In the present embodiment, fixing assemblies 20 in the plurality of bearing mechanisms may be used to fix a plurality of batteries 200, and the plurality of batteries 200 may be conveyed simultaneously under the action of the rotating assembly 10, thereby further reducing the takt time of the battery 200 and improving production efficiency.

In some specific implementations of the present disclosure, the rotating assembly 10 includes: a base 11, a rotating frame 12, and a first driving member 13. The rotating frame 12 is rotatably provided on the base 11 about the first axis, the fixing assembly 20 is provided on the rotating frame 12, and the first driving member 13 is in transmission connection with the rotating frame 12 to drive the rotating frame 12 to rotate about the first axis.

That is to say, as shown in FIGS. 1 and 2, the rotating assembly 10 mainly consists of a base 11, a rotating frame 12, and a first driving member 13. Herein, the base 11 can be formed into a plate-like structure, and the laser welding device 80 is provided on the base 11. The first end of the rotating frame 12 is fixedly connected to a rotating shaft, the axis of which coincides with the first axis. The rotating shaft is rotatably provided on the base 11 about its own axis. The first driving member 13 can be formed as a motor, which can be fixedly connected to the base 11, and the output shaft of the motor is in transmission connection with the rotating shaft. The connection between the output shaft of the motor and the rotating shaft includes, but is not limited to, the following three cases:

Case 1: the output shaft of the motor is directly connected to the rotating shaft; case 2: the output shaft of the motor is connected to the rotating shaft through a gear; case 3: the output shaft of the motor is connected to a transmission wheel through a belt.

In addition to the above structure, the rotating assembly 10 may also be implemented as a belt conveyor, with the fixing assembly 20 provided on the conveyor belt of the belt conveyor, as long as it can drive the fixing assembly 20 to rotate about the first axis, which will not be described in detail in the present embodiment.

According to one embodiment of the present disclosure, the fixing assembly 20 includes: a first mounting seat 21, a first pressing head 22, a second mounting seat 23, and a second pressing head 24.

Specifically, the first mounting seat 21 is provided on the rotating assembly 10, the first pressing head 22 is rotatably provided on the first mounting seat 21 about the second axis, and the second pressing head 24 is arranged spaced apart from the first pressing head 22 along the length direction of the second axis, and is rotatably provided on the first mounting seat 21 about the second axis. The first mounting seat 21 and/or the second mounting seat 23 is movably provided on the rotating assembly 10 along the length direction of the second axis to switch the fixing assembly 20 between the first state and the second state.

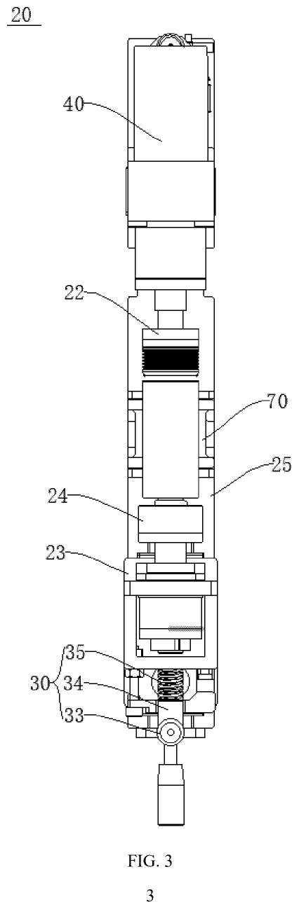

In other words, as shown in FIGS. 3 to 8, the rotating assembly 10 is provided with a mounting plate 25 for installing the fixing assembly 20. The fixing assembly 20 mainly consists of a first mounting seat 21, a first pressing head 22, a second mounting seat 23, and a second pressing head 24. Herein, the first mounting seat 21 is provided on the mounting plate 25, and is provided with a first mounting channel adapted for installing the first pressing head 22. The first end of the first pressing head 22 is rotatably provided in the first mounting channel.

As shown in FIGS. 3 to 8, the first mounting seat 21 and/or the second mounting seat 23 are movably provided on the mounting plate 25 along the length direction of the second axis. The side of the second mounting seat 23 facing the first mounting seat 21 is provided with a second mounting channel adapted for installing the second pressing head 24. The first end of the second pressing head 24 is rotatably provided in the second mounting channel, and the second end of the second pressing head 24 is spaced apart from the second end of the first pressing head 22 along the length direction of the second axis, thereby forming a positioning space for fixing the battery 200. The first mounting seat 21 and/or the second mounting seat 23 can enable the fixing assembly 20 to switch between the first state and the second state, bringing the second pressing head 24 closer to or farther from the first pressing head 22. Thus, the battery 200 can be fixed and released through the cooperation of the first pressing head 22 and the second pressing head 24.

In some specific implementations of the present disclosure, the second mounting seat 23 is movable along the length direction of the second axis, and the fixing assembly 20 further includes: a second driving member 30 and a third driving member 40. The second driving member 30 is provided on the second mounting seat 23 and drives the second mounting seat 23 to move along the length direction of the second axis, so that the first pressing head 22 and the second pressing head 24 cooperate to clamp the battery 200, the third driving member 40 is in transmission connection with either the first pressing head 22 or the second pressing head 24 to drive either the first pressing head 22 or the second pressing head 24 to rotate, and the first pressing head 22 and the second pressing head 24 cooperate to drive the battery 200 to rotate about the second axis.

That is to say, as shown in FIGS. 3 to 6, the second mounting seat 23 is movably provided on the mounting plate 25 along the length direction of the second axis, and is provided with a second driving member 30. By means of the second driving member 30, it is possible to drive the second mounting seat 23 to move along the length direction of the second axis, bringing the second pressing head 24 closer to or farther from the first pressing head 22. Thus, the battery 200 can be fixed and released by the cooperation of the first pressing head 22 and the second pressing head 24. At least one of the first pressing head 22 and the second pressing head 24 is in transmission connection with the third driving member 40. The following provides a detailed explanation using the first pressing head 22 as an example, the first mounting seat 21 is fixedly connected to the third driving member 40. The third driving member 40 can be a motor, the output end of which is connected to the first pressing head 22 through a circular transmission belt and two transmission wheels. When the motor rotates, the first pressing head 22 may be actuated to rotate about the second axis through the circular transmission belt and two transmission wheels, such that when the first pressing head 22 and the second pressing head 24 fix the battery 200, the battery 200 can be actuated to rotate about the second axis, thereby ensuring the circumferential welding of the battery 200 by the laser welding device 80.

According to one embodiment of the present disclosure, the first mounting seat 21 is movable along the length direction of the second axis. The fixing assembly 20 further includes a fourth driving member 50, which is provided on the first mounting seat 21 to drive the second mounting seat 23 to move along the length direction of the second axis.

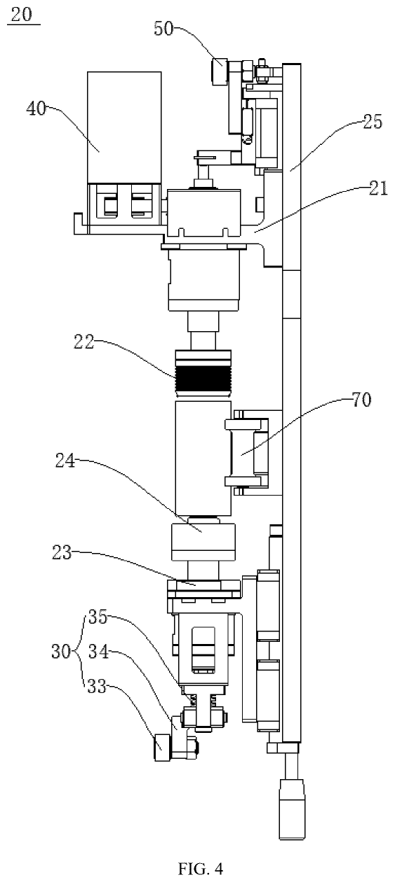

Specifically, as shown in FIG. 4, both the first mounting seat 21 and the second mounting seat 23 can move along the length direction of the second axis. When fixing the battery 200, the first mounting seat 21 and the second mounting seat 23 move closer to each other, so that the first pressing head 22 and the second pressing head 24 respectively abut against the two ends of the battery 200. When releasing the battery 200, the first mounting seat 21 and the second mounting seat 23 move away from each other, so that the first pressing head 22 and the second pressing head 24 release the battery 200. The first mounting seat 21 is provided with a fourth driving member 50, and by means of the fourth driving member 50, it is possible to drive the first mounting seat 21 to move along the length direction of the second axis, bringing the first pressing head 22 closer to or farther from the second pressing head 24.

In some specific implementations of the present disclosure, the second pressing head 24 is movably provided on the second mounting seat 23 along the length direction of the second axis, and the fixing assembly 20 further includes a first elastic member 60 provided between the second pressing head 24 and the second mounting seat 23, with the first end of the first elastic member 60 abutting against the second pressing head 24 and the second end of the first elastic member 60 abutting against the second mounting seat 23.

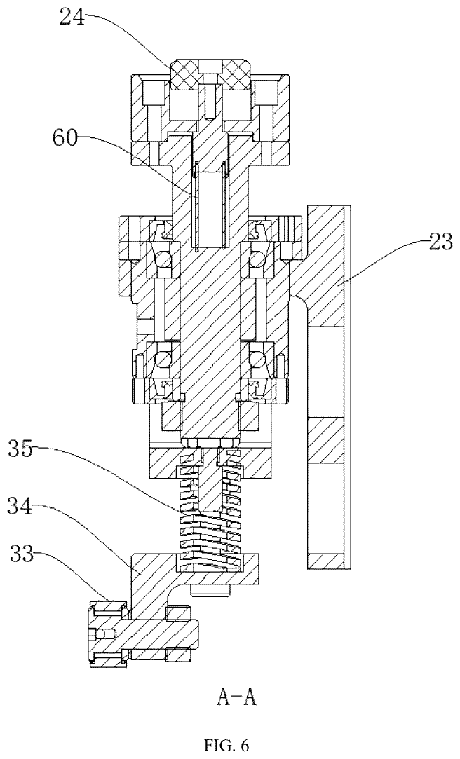

That is to say, as shown in FIG. 6, the second pressing head 24 is not only rotatable about the second axis but also movable along the length direction of the second axis. The first elastic member 60 is provided between the first end of the second pressing head 24 and the second mounting seat 23, can be formed as a compression spring, and is located within the second mounting channel.

The first elastic member 60 can buffer the forces exerted on the battery 200 by the first pressing head 22 and the second pressing head 24, thereby improving the fixing effect of the first pressing head 22 and the second pressing head 24 on the battery 200, and also preventing damage to the battery 200 caused by the first pressing head 22 and the second pressing head 24.

Additionally, an elastic member can also be provided between the first pressing head 22 and the first mounting seat 21. By means of the elastic member, it is possible to buffer the force exerted on the battery 200 by the first pressing head 22, further preventing damage to the battery 200 by the first pressing head 22.

According to one embodiment of the present disclosure, the second driving member 30 includes: a guiding cam 31 and a transmission part 33. The guiding cam 31 is provided on the base 11 and is provided with a guiding part 32 extending in a circumferential direction of the first axis. The guiding part 32 includes a protruding section 321 protruding along the length direction of the first axis and a recessed section 322 recessed along the length direction of the first axis. The transmission part 33 is connected to the second mounting seat 23 and abuts against the guiding part 32 about the first axis. The transmission part 33 cooperates with the protruding section 321 and the recessed section 322 to drive the second mounting seat 23 to move along the length direction of the second axis.

In other words, as shown in FIGS. 2 and 9, the second driving member 30 mainly consists of a guiding cam 31 and a transmission part 33. Herein, the guiding cam 31 is formed as an annular structure, and the rotating frame 12 is located inside the guiding cam 31 and is rotatably connected to the base 11. The guiding cam 31 has a guiding part 32, which is an annular structure extending along the circumferential direction of the guiding cam 31. The guiding part 32 includes a protruding section 321 and a recessed section 322, which are staggered along the length direction of the first axis. The transmission part 33 is connected to the second mounting seat 23, such that the transmission part 33 may move synchronously with the second mounting seat 23, and a part of the transmission part 33 is abutted inside the guiding part 32. As the second mounting seat 23 is rotated about the first axis, the transmission part 33 rotates about the first axis within the guiding part 32.

When the transmission part 33 rotates from the recessed section 322 to the protruding section 321, the second mounting seat 23 actuates the second pressing head 24 closer to the first pressing head 22 to clamp and fix the battery 200. When the transmission part 33 rotates from the protruding section 321 to the recessed section 322, the second mounting seat 23 actuates the second pressing head 24 away from the first pressing head 22 to release the fixed battery 200.

It should be noted that the guiding part 32 may be configured as a groove structure with a slope or a boss structure with a slope, depending on the actual requirements. The lengths of the protruding section 321 and the recessed section 322 of the guiding part 32 are determined based on the welding zone, the unloading zone, and the loading zone. The number of the protruding sections 321 and the recessed sections 322 can also be multiple, and the specific number thereof can be determined based on the positions of the welding zone, the loading position and the material-discharging position, as long as the battery 200 can be fixed in the welding zone, be released in the unloading zone, and be installed and fixed in the loading zone, which is not limited in the present embodiment.

In the present embodiment, by cooperating the transmission part 33 with the protruding section 321 and the recessed section 322, it is possible to drive the second mounting seat 23 to move along the length direction of the second axis, and fix or release the battery 200 precisely at the required positions without the need for electronic components, thereby ensuring high reliability.

The fourth driving member 50 can have the same structure as the second driving member 30 or a different one. When the fourth driving member 50 has the same structure as the second driving member 30, the above-mentioned structure can be used to drive the first mounting seat 21 to move, which will not be repeated in the present disclosure.

In some specific implementations of the present disclosure, the second driving member 30 further includes: an adapter member 34 and a second elastic member 35. The transmission part 33 is rotatably provided on the adapter member 34 about its own axis, and the adapter member 34 is movably provided on the second mounting seat 23 along the length direction of the second axis. The second elastic member 35 is provided between the adapter member 34 and the second mounting seat 23, with the first end of the second elastic member 35 abutting against the adapter member 34 and the second end of the second elastic member 35 abutting against the second mounting seat 23.

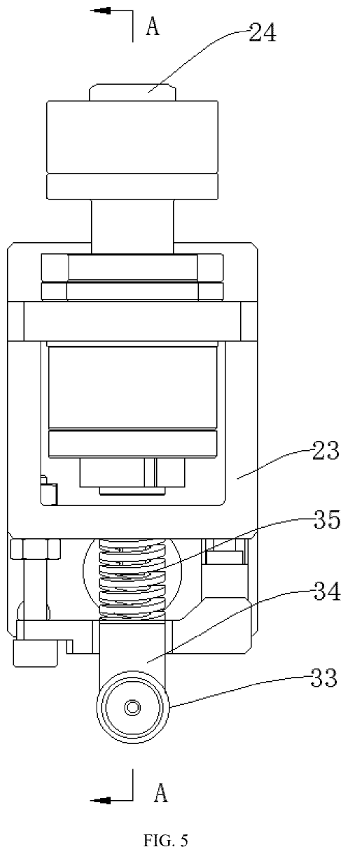

That is to say, as shown in FIGS. 5 and 6, the second driving member 30 further includes an adapter member 34 and a second elastic member 35. The second mounting seat 23 is provided with a third mounting channel extending along the length direction of the second axis at the end away from the first mounting seat 21. The first end of the adapter member 34 is movably provided within the third mounting channel along the axis of the third mounting channel.

The transmission part 33 can be formed as a roller structure, with its axis perpendicular to the first axis. The transmission part 33 is rotatably provided on the second end of the adapter member 34 about its own axis, which can reduce the friction between the transmission part 33 and the guiding part 32 and improve the smoothness of the transmission part 33 during rotation.

As shown in FIGS. 5 and 6, the second elastic member 35 is formed as a compression spring. The first end of the second elastic member 35 abuts against the adapter member 34, and the second end of the second elastic member 35 abuts against the second mounting seat 23. By means of the second elastic member 35, it is possible to buffer the force exerted on the second mounting seat 23 by the transmission part 33, and thus buffer the force exerted on the battery 200 by the second pressing head 24, thereby effectively preventing damage to the battery 200 caused by the second pressing head 24.

According to one embodiment of the present disclosure, the bearing mechanism further includes: two limit rollers 70. The axes of the two limit rollers 70 are parallel to the second axis. The two limit rollers 70 are spaced apart in the radial direction of the battery 200, are rotatably provided on the rotating assembly 10 about their own axes, and cooperate to bear the battery 200.

Specifically, as shown in FIGS. 3 and 4, the mounting plate 25 is provided with two limit rollers 70, which are spaced apart in the radial direction of the battery 200 with a spacing distance less than the diameter of the battery 200. When loading the battery 200, the outer peripheral surfaces of the two limit rollers 70 can both abut against the outer peripheral surface of the battery 200, and thus define the position of the battery 200 relative to the first pressing head 22 and the second pressing head 24. Moreover, the two limit rollers 70 can rotate about their own axes. As the battery 200 is rotated, the limit rollers 70 can rotate along with it, thereby preventing damage to the battery 200 caused by the limit rollers 70.

In some specific implementations of the present disclosure, the laser welding device 80 further includes a position sensor, which is configured to detect the position of the battery 200 in the welding zone.

That is to say, the laser welding device 80 is provided with a position sensor, and the position sensor is electrically connected to the control terminal of the laser welding device 80. By means of the position sensor, it is possible to detect the position of the battery 200 in the welding zone, and the control terminal can control the laser welding device 80 to perform continuous welding on the battery 200 based on the detected position by the position sensor.

Although the present disclosure has been described in detail with reference to certain specific embodiments and illustrative examples, it is understood by those skilled in the art that the above examples are provided solely for the purpose of illustration and are not intended to limit the scope of the present disclosure. Those skilled in the art should understand that modifications and variations may be made to the above embodiments without departing from the scope and spirit of the present disclosure. The scope of the present disclosure is defined by the appended claims.

1. A welding device, comprising:
a rotating assembly;
at least one bearing mechanism, provided on the rotating assembly and actuated by the rotating assembly to rotate about a first axis, thereby cycling through a welding zone, an unloading zone, and a loading zone; wherein the bearing mechanism comprises at least a fixing assembly, which is switchable between a first state and a second state, wherein the fixing assembly fixes a battery and at least a part of the fixing assembly is rotatable about a second axis to actuate the battery to rotate about the second axis in the first state, and wherein the fixing assembly releases the battery in the second state; and
a laser welding device comprising at least a laser unit and a galvanometer unit, and the galvanometer unit being configured to deflect a laser emitted by the laser unit so that the laser welds a welding part of the battery when the battery is rotated about the first axis and the second axis.

2. The welding device according to claim 1, wherein the rotating assembly comprises:
a base and a rotating frame, the rotating frame being rotatably provided on the base about the first axis, and the fixing assembly being provided on the rotating frame; and
a first driving member being in a transmission connection with the rotating frame to drive the rotating frame to rotate about the first axis.

3. The welding device according to claim 1, wherein the fixing assembly comprises:
a first mounting seat and a first pressing head, the first mounting seat being provided on the rotating assembly, and the first pressing head being rotatably provided on the first mounting seat about the second axis; and
a second mounting seat and a second pressing head, the second pressing head being arranged spaced apart along a direction of the second axis from the first pressing head, and the second pressing head being rotatably provided on the second mounting seat about the second axis;
wherein the first mounting seat and/or the second mounting seat is movably provided on the rotating assembly along a direction of the second axis, so that the fixing assembly is switchable between the first state and the second state.

4. The welding device according to claim 3, wherein the second mounting seat is movable along the direction of the second axis, and the fixing assembly further comprises:
a second driving member provided on the second mounting seat and driving the second mounting seat to move along a length direction of the second axis, so that the first pressing head and the second pressing head are coupled to clamp the battery; and
a third driving member being in a transmission connection with the first pressing head or the second pressing head to drive the first pressing head or the second pressing head to rotate, the first pressing head and the second pressing head being coupled to drive the battery to rotate about the second axis.

5. The welding device according to claim 3, wherein the first mounting seat is movable along a length direction of the second axis, and the fixing assembly further comprises:
a fourth driving member provided on the first mounting seat to drive the second mounting seat to move along the length direction of the second axis.

6. The welding device according to claim 3, wherein the second pressing head is movably provided on the second mounting seat along a length direction of the second axis, and the fixing assembly further comprises:
a first elastic member provided between the second pressing head and the second mounting seat, a first end of the first elastic member abutting against the second pressing head, and a second end of the first elastic member abutting against the second mounting seat.

7. The welding device according to claim 2, wherein the second driving member comprises:
a guiding cam provided on the base and provided with a guiding part extending in a circumferential direction of the first axis, the guiding part comprising a protruding section protruding along a length direction of the first axis and a recessed section recessed along the length direction of the first axis; and
a transmission part connected to the second mounting seat, rotatably abutting against the guiding part about the first axis and cooperating with the protruding section and the recessed section to drive the second mounting seat to move along the length direction of the second axis.

8. The welding device according to claim 7, wherein the second driving member further comprises:
an adapter member, the transmission part being rotatably provided on the adapter member about a rotational axis, and the adapter member being movably provided on the second mounting seat along the length direction of the second axis; and
a second elastic member provided between the adapter member and the second mounting seat, a first end of the second elastic member abutting against the adapter member, and a second end of the second elastic member abutting against the second mounting seat.

9. The welding device according to claim 1, wherein the bearing mechanism further comprises:
two limit rollers, comprising axes thereof being parallel to the second axis, and the two limit rollers being spaced apart in a radial direction of the battery, being rotatably provided on the rotating assembly about the axes thereof, and being coupled to bear the battery.

10. The welding device according to claim 1, wherein the laser welding device further comprises:
a position sensor configured to detect a position of the battery in the welding zone.

11. The welding device according to claim 2, wherein the fixing assembly comprises:
a first mounting seat and a first pressing head, the first mounting seat being provided on the rotating assembly, and the first pressing head being rotatably provided on the first mounting seat about the second axis; and
a second mounting seat and a second pressing head, the second pressing head being arranged spaced apart along a direction of the second axis from the first pressing head, and the second pressing head being rotatably provided on the second mounting seat about the second axis;
wherein the first mounting seat and/or the second mounting seat is movably provided on the rotating assembly along the direction of the second axis, so that the fixing assembly is switchable between the first state and the second state.

12. The welding device according to claim 11, wherein the second mounting seat is movable along the direction of the second axis, and the fixing assembly further comprises:
a second driving member provided on the second mounting seat and driving the second mounting seat to move along a length direction of the second axis, so that the first pressing head and the second pressing head are coupled to clamp the battery; and
a third driving member being in transmission connection with the first pressing head or the second pressing head to drive the first pressing head or the second pressing head to rotate, the first pressing head and the second pressing head being coupled to drive the battery to rotate about the second axis.

13. The welding device according to claim 4, wherein the first mounting seat is movable along a length direction of the second axis, and the fixing assembly further comprises:
a fourth driving member provided on the first mounting seat to drive the second mounting seat to move along the length direction of the second axis.

14. The welding device according to claim 11, wherein the first mounting seat is movable along a length direction of the second axis, and the fixing assembly further comprises:
a fourth driving member provided on the first mounting seat to drive the second mounting seat to move along the length direction of the second axis.

15. The welding device according to claim 12, wherein the first mounting seat is movable along a length direction of the second axis, and the fixing assembly further comprises:
a fourth driving member provided on the first mounting seat to drive the second mounting seat to move along the length direction of the second axis.

16. The welding device according to claim 4, wherein the second pressing head is movably provided on the second mounting seat along a length direction of the second axis, and the fixing assembly further comprises:
a first elastic member provided between the second pressing head and the second mounting seat, a first end of the first elastic member abutting against the second pressing head, and a second end of the first elastic member abutting against the second mounting seat.

17. The welding device according to claim 5, wherein the second pressing head is movably provided on the second mounting seat along a length direction of the second axis, and the fixing assembly further comprises:
a first elastic member provided between the second pressing head and the second mounting seat, a first end of the first elastic member abutting against the second pressing head, and a second end of the first elastic member abutting against the second mounting seat.

18. The welding device according to claim 11, wherein the second pressing head is movably provided on the second mounting seat along a length direction of the second axis, and the fixing assembly further comprises:
a first elastic member provided between the second pressing head and the second mounting seat, a first end of the first elastic member abutting against the second pressing head, and a second end of the first elastic member abutting against the second mounting seat.

19. The welding device according to claim 12, wherein the second pressing head is movably provided on the second mounting seat along a length direction of the second axis, and the fixing assembly further comprises:
a first elastic member provided between the second pressing head and the second mounting seat, a first end of the first elastic member abutting against the second pressing head, and a second end of the first elastic member abutting against the second mounting seat.

20. The welding device according to claim 13, wherein the second pressing head is movably provided on the second mounting seat along a length direction of the second axis, and the fixing assembly further comprises:
a first elastic member provided between the second pressing head and the second mounting seat, a first end of the first elastic member abutting against the second pressing head, and a second end of the first elastic member abutting against the second mounting seat.
